(19) United States
(12) Patent Application Publication
(10) Pub. No.: US 2015/0324846 A1
(43) Pub. Date: Nov. 12, 2015

(54) USING CARD-LINKED OFFER DATA TO DETECT USER INTERESTS

(71) Applicant: MICROSOFT CORPORATION, REDMOND, WA (US)

(72) Inventors: BORIS FELDMAN, SEATTLE, WA (US); GENE M. DECLARK, KIRKLAND, WA (US); JOSE SAURA, KENT, WA (US)

(73) Assignee: MICROSOFT CORPORATION, REDMOND, WA (US)

(21) Appl. No.: 14/274,102

(22) Filed: May 9, 2014

(51) Int. Cl. G06Q 30/02

(52) U.S. Cl. CPC G06Q 30/0256

(57) ABSTRACT

Aspects of the present invention utilize card-linked offer data to determine a user's interests. In one aspect, the card-linked offer data is analyzed by a card-linked offer system to determine user interests. The user interests are then transferred to other applications, such as a search engine or advertising system, that use the interest information to select relevant content. In another aspect, the card-linked offer data is transferred to other applications that use the data to determine user interests. The card-linked offer data may be combined with other information, such as a user's browsing history, search history, social network posts, and such, to determine a user's interest.

### BACKGROUND

As computing systems have become ubiquitous in society, digital content has proliferated. With the large quantities of digital content now available, it has become increasingly important to identify and present digital content that is relevant to a user. For example, the user may enter a search query into a search engine to locate relevant websites or other digital content. The search engine can analyze large volumes of digital content in order to identify the relevant digital content. In doing so, the search engine may evaluate the search query to determine the user's intent so as to provide relevant search results.

Search engines and advertising systems can use browsing history and search logs to determine a user's interests. The user's interests can be used to determine the relevance of search results and advertisements to the user. The user interests may be expressed as advertising segments. The advertising segments obscure the actual browsing history and search logs by assigning a generic interest, such as sports fan, potential car purchaser, and such.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the present invention utilize card-linked offer data to determine a user's interests. In one aspect, the card-linked offer data is analyzed by a card-linked offer system to determine user interests. The user interests are then transferred to other applications, such as a search engine or advertising system, that use the interest information to select relevant content. In another aspect, the card-linked offer data is transferred to other applications that use the data to determine user interests. The card-linked offer data may be combined with other information, such as a user's browsing history, search history, social network posts, and such, to determine a user's interest.

A card-linked offer is an incentive tied to a user's credit card or other form of electronic payment. The incentive may take the form of a monetary discount, refund, or a non-monetary reward in the form of an electronic currency (e.g., phone minutes, additional data) or other value (e.g., loyalty points). As used herein, the term “credit card” includes all bank cards (e.g., ATM cards) and digital payment methods, such as near field communication chips and mobile phones. The discount tied to the offer may be (but is not required to be) credited to the user as part of the electronic payment method.

A user's interactions with card-linked offers can generate card-linked offer data. User interactions can include various interactions with an offer, including ignoring an offer and accepting an offer. An offer is accepted when the offer is linked to the user's credit card. Once accepted, the offer can be redeemed when the user makes a purchase consistent with the offer using the credit card.

Further data may be available when an offer invitation is ignored, such as whether or not the user read the offer invitation. User interactions can also include redeeming an accepted offer with a vendor. Additional data associated with a redemption can include a time of purchase and a location of the vendor where the purchase was made.

In one aspect, the card-linked offer data is transformed into a format that is consumable by an existing interest determination component. An interest determination component (or engine) may be used by a search engine, an advertising system, a service provider, or others to determine a user's interest. The interest determination engine may take the form of a machine classifier. The machine classifier may be trained to receive a particular type of data as input. For example, a machine classifier used by a search engine may take user queries, click logs, and browsing history as input. In one aspect, the card-linked offer data, which does not include queries, is used to generate one or more artificial queries using information within the offer data. In addition to an artificial query, an artificial browsing history entry could be created. The artificial queries, artificial browsing history, and other forms of artificial search records are created to work with various classifiers that may already exist for these types of data (e.g., queries, browsing history, etc.). Generating artificial search records potentially allows the existing classifiers to process card-linked offer information without retraining the classifiers or building new classifiers. Alternatively, if new classifiers are built to process card-linked offer information, then providing the card-linked offer data to the classifier in a form (e.g. artificial search records) used in existing classifiers can simplify the development process.

The artificial browsing entry could describe the offer in terms similar to a webpage that a user navigated to. The frequency of navigation can be changed within the entry to reflect whether or not the user accepted an offer or redeemed an offer. Thus, the artificial browsing entry could indicate that a user visited a webpage having keywords within the offer ten times when the user redeemed the offer and three times when the user accepted the offer.

### BRIEF DESCRIPTION OF THE DRAWINGS

Aspects of the invention are described in detail below with reference to the attached drawing figures, wherein:

FIG. 1 is a block diagram of an exemplary computing environment suitable for implementing aspects of the invention;

FIG. 2 is a diagram of a card-linked offer environment suitable for using card-linked offer data to determine user interest, in accordance with an aspect of the present invention;

FIG. 3 is a diagram of a card-linked offer environment suitable for using card-linked offer data to determine user interest, in accordance with an aspect of the present invention;

FIG. 4 is a flow chart showing a method for using card-linked offer data to detect user interests, in accordance with an aspect of the present invention;

FIG. 5 is a flow chart showing a method for using card-linked offer data to detect user interests, in accordance with an aspect of the present invention;

FIG. 6 is a flow chart showing a method for using card-linked offer data to detect user interests, in accordance with an aspect of the present invention; and

FIG. 7 is a map depicting a user's preferred shopping districts in accordance with one aspect of the present invention.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present invention utilize card-linked offer data to determine a user's interests. In one aspect, the card-linked offer data is analyzed by a card-linked offer system to determine user interests. The user interests are then transferred to other applications, such as a search engine or advertising system, that use the interest information to select relevant content. In another aspect, the card-linked offer data is transferred to other applications that use the data to determine user interests. The card-linked offer data may be combined with other information, such as a user's browsing history, search history, social network posts, and such, to determine a user's interest.

As used herein, a “user interest” is statistically inferred from observable user actions. For example, a machine classifier may be used to determine a user's interest by evaluating a user's actions. The user's actions may be compared within the classifier against training data that is labeled according to one or more interests. Generally, a user can be said to have an interest when the user's actions are similar to tagged actions associated with the interest. “User interest” does not require an actual mental state or emotion of the user.

A card-linked offer is an incentive tied to a user's credit card or other form of electronic payment. The incentive may take the form of a monetary discount, refund, or a non-monetary reward in the form of an electronic currency (e.g., phone minutes, additional data) or other value (e.g., loyalty points). As used herein, the term “credit card” includes all bank cards (e.g., ATM cards) and digital payment methods, such as near field communication chips and mobile phones. The discount tied to the offer may be (but is not required to be) credited to the user as part of the electronic payment method.

To be eligible to receive offers, a user may opt in or subscribe to the card-linked offer service. The card-linked offer service works on behalf of merchants to promote offers to individual users. A user may choose to link one or more of their credit cards within the service. The incentive associated with the offer is automatically given to the user when a payment method linked to this service is used to make the purchase.

A user's interactions with card-linked offers can generate card-linked offer data. User interactions can include various interactions with an offer, including ignoring an offer and accepting an offer. An offer is accepted when the offer is linked to the user's credit card. Once accepted, the offer can be redeemed when the user makes a purchase consistent with the offer using the credit card.

Further data may be available when an offer invitation is ignored, such as whether or not the user read the offer invitation. User interactions can also include redeeming an accepted offer with a vendor. Additional data associated with a redemption can include a time of purchase and a location of the vendor where the purchase was made.

In another instance, an offer is accepted and not redeemed, though an unsuccessful attempt to redeem the offer is detected. The reason for the unsuccessful attempt can be another signal for an interest classifier. For example, an unsuccessful redemption attempt can occur when the user tries to redeem the offer by visiting a participating merchant but didn't meet the offer's qualifications. The user's non-conformance with the offer qualifications can provide useful information about the user. This information can be used to detect user interests and adjust future offers, and provide content that matches the user interests. For example, a user may try to redeem an offer at one of a merchants non-participating locations. This signal can nevertheless be used to determine an affinity for the store location where the attempt to redeem was made.

In addition to interactions, card-linked offer data can include offer details. Offer details for accepted offer invitations and redeemed offers may be compared to offer details for non-accepted offers, or accepted but non-redeemed offers, to detect interests. For example, the comparison of offer details may reveal the user responds positively to offers that emphasize convenience, environmental friendliness, health food, novelty, or certain types of discounts. For example, a user may prefer a 50% discount to a buy-one-get-one-free discount. Another user may prefer loyalty discounts that incentivize purchases with familiar vendors. A user attracted to novelty may prefer offers for unknown vendors or new items with a familiar vendor.

In one aspect, the card-linked offer data is transformed into a format that is consumable by an existing interest determination engine. An interest determination engine may be used by a search engine, an advertising system, a service provider, or others to determine a user's interest. The interest determination engine may take the form of a machine classifier. The machine classifier may be trained to receive a particular type of data as input. For example, a machine classifier used by a search engine may take user search records in the form of queries, click logs, and browsing history as input. In one aspect, the card-linked offer data, which does not include queries, is used to generate one or more artificial queries using information within the offer data.

The artificial queries, artificial browsing history, and other forms of artificial search records are created to work with various classifiers that may already exist for these types of data (e.g., queries, browsing history, etc.). Generating artificial search records potentially allows the existing classifiers to process card-linked offer information without retraining the classifiers or building new classifiers. Alternatively, if new classifiers are built to process card-linked offer information, then providing the card-linked offer data to the classifier in a form (e.g. artificial search records) used in existing classifiers can simplify the development process.

In addition to an artificial query, an artificial browsing history entry could be created. For example, the artificial browsing entry could describe the offer in terms similar to a webpage that a user navigated to. The frequency of navigation can be changed within the entry to reflect whether or not the user accepted an offer or redeemed an offer. Thus, the artificial browsing entry could indicate that a user visited a webpage having keywords within the offer ten times when the user redeemed the offer and three times when the user accepted the offer.

A machine classifier may be trained to interpret card-linked offer data to assign a user interest. A supervised learning approach may be used to train the machine classifier. In one aspect, card-linked offer data is editorially tagged to create a corpus of training data for the machine classifier. The training data is then used to calculate an interest upon receiving card-linked offer data for a particular user.

Certain interests may be ascertained by evaluation of card-linked offer data apart from a classifier. For example, a heat map could be generated to determine where a user likes to shop. Shopping districts associated with multiple redeemed offers will receive a higher ranking on the heat map than shopping districts where fewer or no offers have been redeemed. Similarly, a preferred shopping time may be determined by analyzing when offers are redeemed.

In one aspect, user interests determined using card-linked offer data may be combined with user interests determined by classifiers taking other user interest signals as input. The different interest determinations may be weighed against each other to form a combined user interest profile. For example, a first classifier may determine a user interest based on search logs, a second classifier may determine a user interest based on browsing history, a third classifier may determine a user interest based on analysis of the user's social network, and a fourth classifier may determine a user interest by analyzing card-linked offer data. The user interest profile may include a ranking of interests or interest strengths. In one aspect, the card-linked offer data interest determination is given more weight than other classifiers when generating the combined user interest profile.

The card-linked offer system can provide offers that are customized for individuals and that may only be used by the individual. For example, an offer linked to an individual's credit card may only be realized by using the credit card to purchase the good or service. Accordingly, only those authorized to use the credit card can take advantage of the offer. Multiple users may receive the same discount on a good or service, but each user will have a unique offer that allows the user to realize the discount when making a purchase. In this way, the offers are not directly transferable from user to user.

Offers may be customized according to merchant rules that are based on a recipient's characteristics. Relevant recipient characteristics include recipient demographics, recipient purchase history, and recipient interests. In some aspects, the recipient characteristics may prevent the recipient from being eligible for an offer. For example, an offer for a discount at a restaurant may be limited to people living less than a threshold distance from the restaurant. A recipient's purchase history may be used to determine whether an individual is a potentially new customer or returning customer. Returning customers may receive a loyalty incentive, while potentially new customers may receive a different offer with a heightened incentive to become a first time customer.

A user's social network may be analyzed to determine that the user has an interest in a product or service. When a user indicates appreciation for a particular product or shares that she visited a location, such as a restaurant, this information may be used to determine the user's interests. Expressing interest in a product or service may be a criteria used to determine whether a particular user is eligible to subscribe to an offer.

The offer service may provide interfaces for merchants and users. The merchant interface allows the merchant to specify the details of an offer and establish recipient characteristics that are used to extend an offer to a given recipient. The merchant may also specify sharing incentives.

The interface for users allows people to subscribe to the sharing service, accept an offer, view active offers, record interests that are used assign particular offers to the user, and establish other preferences. The user may be able to explicitly set their card-linking preferences through the interfaces provided. Their preferences may specify a total number of active offers that may be associated with the user at any one time. The preferences may also specify the types of offers the user is interested in. For example, the user may express a preference for offers related to coffee houses or barbecue restaurants. If the user is in the market for a particular product, the user may indicate this and begin automatically being linked to offers related to that product. For example, the user may indicate that he is in the market for new running shoes. Sporting goods stores and other outlets participating in the offer service will automatically have their offers linked to the user when the offer is relevant to running shoes.

In one aspect, the accepted offers are limited by duration. For example, 1,000 offers may be authorized by the merchant to remain active for one week. The merchant may reauthorize after a week based on results. As users enter the service and their profiles change, the confidence that a user has an interest in a particular offer may change. For example, the user may be notified of an active offer and ignore it for a week, despite driving by a location where the offer could be utilized. This may indicate that the user is less interested than other users in the offer. After a period of time, the offer may be deactivated or delinked to the user and offered to a different user having a higher confidence factor. The confidence factor may be generated by a statistical analysis of user characteristics and behaviors and indicates a degree of confidence that the user has an interest or is likely to utilize the offer.

A merchant may offer multiple offers simultaneously with different goals. For example, a merchant may specify that certain users who have done business with the merchant previously are eligible for a loyalty offer. The loyalty offer encourages a user who is familiar with the business to return, and perhaps try a related product or service. For example, users who have previously had lunch at a restaurant may receive an offer discounting dinner at the restaurant. The merchant may also specify acquisition offers that are designed to lure new customers. In one aspect, the acquisition offers provide a higher incentive than do loyalty offers.

Having briefly described an overview of aspects of the invention, an exemplary operating environment suitable for use in implementing aspects of the invention is described below.

### Exemplary Operating Environment

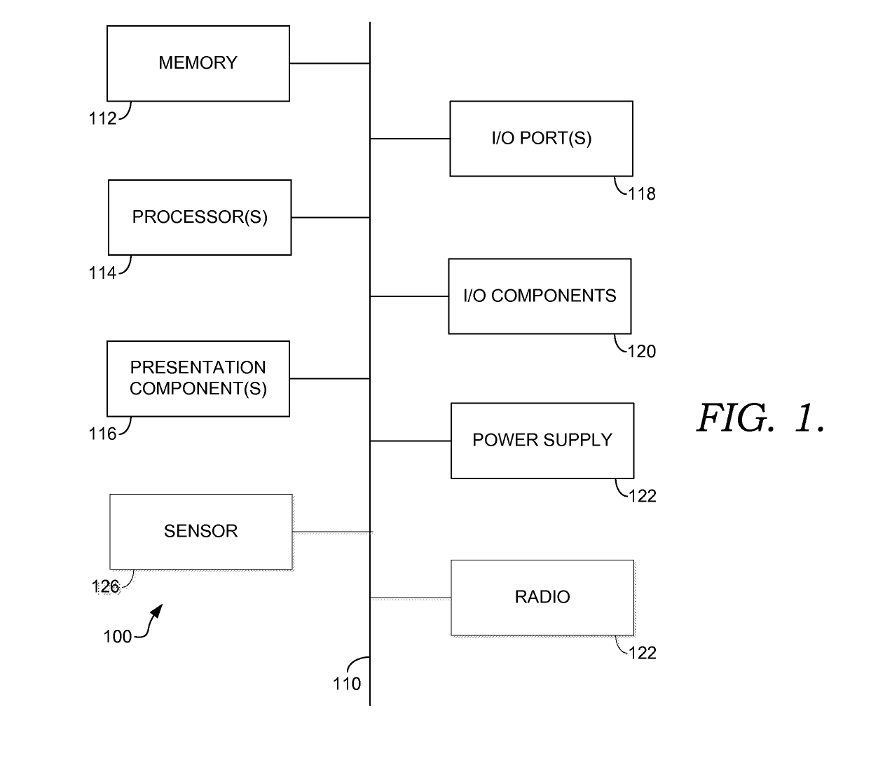

Referring to the drawings in general, and initially to FIG. 1 in particular, an exemplary operating environment for implementing aspects of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the invention may be practiced in a variety of system configurations, including handheld devices, consumer electronics, general-purpose computers, specialty computing devices, etc. Aspects of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more aspects of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a person or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Advertising and Content Service

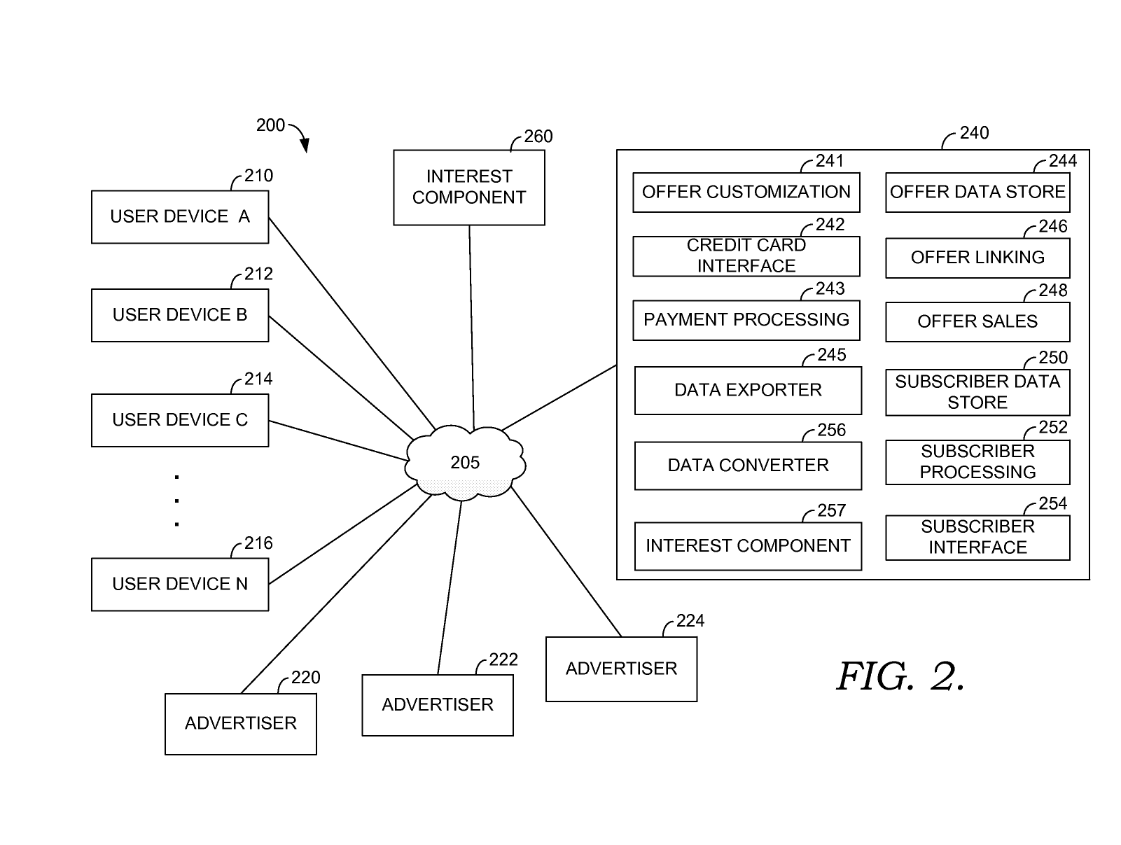

Turning now to FIG. 2, a distributed offer service environment 200 is shown, in accordance with an aspect of the present invention. The environment 200 includes user device A 210, user device B 212, user device C 214, and user device N 216 (hereafter user devices 210-216). User device N 216 is intended to represent that there could be an almost unlimited number of devices connected to network 205. The user devices 210-216 may take different forms. For example, the user devices 210-216 may be game consoles, televisions, DVRs, cable boxes, personal computers, tablets, phones, or other user devices capable of outputting communications.

Network 205 is a wide area network, such as the Internet. Network 205 is connected to advertiser 220, advertiser 222, and advertiser 224. The advertisers 220, 222, and 224 sell products or services associated with offers to linked users of user devices 210-216. The advertisers may also be described as merchants or vendors. The advertisers may have a physical and online presence. In one aspect, the advertiser's offers are only able to be utilized at a physical location, such as a retail store. The advertisers make incentives available to users through the offer service 240. The advertisers may sell the same or similar products or unrelated products.

The offer service 240 may operate in a data store capable of interaction with multiple user devices, credit card companies, and advertisers. The offer service 240 includes an offer customization component 241, a credit card interface 242, a payment processing component 243, an offer data store 244, a data exporter 245, an offer linking component 246, an offer sales component 248, a subscriber data store 250, a subscriber processing component 252, a subscriber interface component 254, a data converter 256, and an interest component 257.

The offer customization component 241 applies business rules when determining whether an offer should be extended to a user to a user. The business models may define eligibility criteria for one or more offers. Eligibility criteria include user characteristics. Each offer may define a separate product or service and an incentive for a product and service. For example, an offer may be applicable to all running shoes of a certain brand offered by a particular merchant. Exemplary incentives include a 20% discount, buy one get one free, buy one pair one pair 50% off, and the like.

When a user has characteristics that match with an available offer, the offer may be extended to the user. An extended offer, as used herein, is an offer to which the user is able to subscribe. The user may choose not to subscribe, but once extended the user has a threshold period of time to subscribe or not. If a user receives an offer invitation from another user and turns out not to be eligible to receive an offer from the associated merchant, then the offer customization component 241 may notify the user. In this situation, the offer customization component 241 may extend a different offer that the user is eligible to receive from a different merchant.

As mentioned, the business rules may specify target audience data for an offer. The business rules may also specify a total number of offers available and circumstances in which an offer is extended and when the offer expires. For example, a user may subscribe to an offer that expires after one week.

The credit card interface 242 is used to instruct credit card companies to apply a discount when card-linked offers are utilized. As mentioned, card-linked offers are a type of offer that may be utilized in aspects of the invention. The credit card interface 242 may also verify the validity of credit card numbers and associate a user with a particular credit card number during user sign up.

The payment processing component 243 may work with a credit card interface 242 to apply a discount to users. In addition, the payment processing component 243 may capture a portion of a purchase or discount and transfer it to an offer service or brokerage that is associated with the merchant. The payment processing component 243 may send a text or email or other communication confirming that the discount has been applied to the user when an offer is utilized.

The offer data store 244 stores offers and customized incentives that have been submitted by advertisers. Each offer and incentive may have criteria derived from the business rules. Each offer can include a description and terms and conditions. For example, the amount of the incentive and where the incentive may be realized is explained. In one aspect, the offer includes graphics that may be presented to the user as part of a notification. In one aspect, the offer includes a geo-notification criteria that indicates a geographic area in which an offer notification or reminder should be presented to the user. In addition to location, other presentation criteria may be associated with an offer notification, such as a time period for presenting a notification.

The offer linking component 246 links card-linked offers to a user's account after a user subscribes. The offer linking component 246 may provide a notification upon performing a link. The offer linking component 246 follows business rules and user preferences when linking.

The offer sales component 248 provides a portal through which advertisers may define offers. In one aspect, the particular subject matter or interests of a group of users are bid on by advertisers. For example, only a single offer for a steakhouse may be active at one time within a geographic area. The various steakhouses may then bid on the opportunity to provide an active offer to a plurality of users. The bidding may specify a willingness to share a percent of the total transaction upon the user utilizing an offer. Other payment methods are possible. The offer sales component 248 may provide a listing of offers presently available to advertisers and help them tailor an offer that is likely to garner interest. The offer sales component 248 may be a gatekeeper that maintains offers fitting parameters that ensure they are likely to be used by above a threshold percentage of consumers.

The subscriber data store 250 tracks profile data for subscribers or users of the offer service. The subscriber data store 250 can include a user's credit card data and other data gathered upon signing up. The subscriber data store 250 may track a user's purchases, offer subscriptions, offer rejections, and other data related to the user's interaction with offers.

The subscriber processing component 252 may build and assign personas using the card-linked offer data, interest categories generated by interest component 257, and a machine-learning algorithm. A persona is an abstraction of a person or groups of people that describes preferences or characteristics about the person or groups of people. The persona may be a collection of advertising segments. An advertising segment is a category of interest that is mapped to categories of advertisements. The personas may be based on media content the persons have viewed or listened to, as well as other personal information stored in a user profile on the user device (e.g., card-linked offer profile) and associated with the person. For example, the persona could define a person as a female between the ages of 20 and 25 having an interest in science fiction, movies, and sports. Similarly, a person that shows interest in cars may be assigned a persona of “car enthusiast.” More than one persona may be assigned to an individual or group of individuals. For example, a family of five may have a group persona of “animated film enthusiasts” and “football enthusiasts.” Within the family, a child may be assigned a persona of “likes video games,” while the child's mother may be assigned a person of “dislikes video games.” It will be understood that the examples provided herein are merely exemplary. Any number or type of personas may be assigned to a person.

The subscriber interface component 254 provides an interface through which the subscriber or user may view active offers associated with their credit cards and express preferences and rules governing autolinking of offers. The offers may be delineated by subject matter, location, specific vendors, and other factors. For example, the user may request not to be linked to offers for coffee shops. The preferences may identify specific advertisers the user wants to express a preference for linking or prohibition for linking. The preferences may also specify categories of products and services that are of interest to a user. The subscriber interface component 254 may provide a privacy component that allows a user to opt in or opt out of sharing of any type of information. The user may also be given the opportunity to opt in or opt out of the use of any information available to the offer service 240.

Interest component 260 uses one or more computerized methods to determine a user's interests. For the sake of simplicity, a single interest component 260 is shown. In an actual embodiment, multiple interest components 260 may be in communication with the card-linked offer service 240. The interest component 260 can be associated with a content provider, such as a search engine, that uses the interests to surface relevant content. An individual content provider may use multiple automated methods to determine a user's interests. For example, the interest component 260 may use multiple classifiers to detect a user's interest. Each classifier may take different interest signals as input. For example, a first classifier may take a browsing history as input and a second classifier may take query logs as input. Results from the classifiers may be combined into an interest profile.

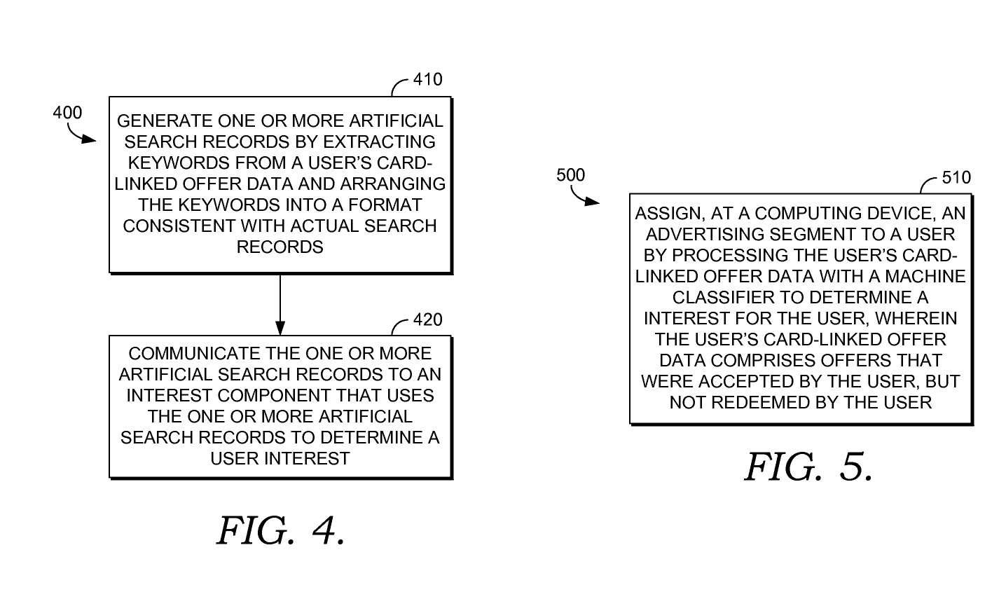

The data exporter 245 communicates card-linked offer data to the interest component 260. The card-linked offer data may be in the form of raw data or modify data. For example, the modified data can include artificial search records and advertising segments. The modified card-linked offer data may be generated by data converter 256. Data converter 256 can generate artificial query records, artificial queries, artificial click logs, artificial browsing history, and other forms of data derived from the card-link offer data. Methods of generating the artificial search records will be described subsequently with reference to FIG. 4.

The interest component 257 can consume card-linked offer data to determine a user interest. The user interest may be used to assign advertising segments to the user. The user interest may be exported or used by the card-linked offer system 240 to select offers for representation to the user.

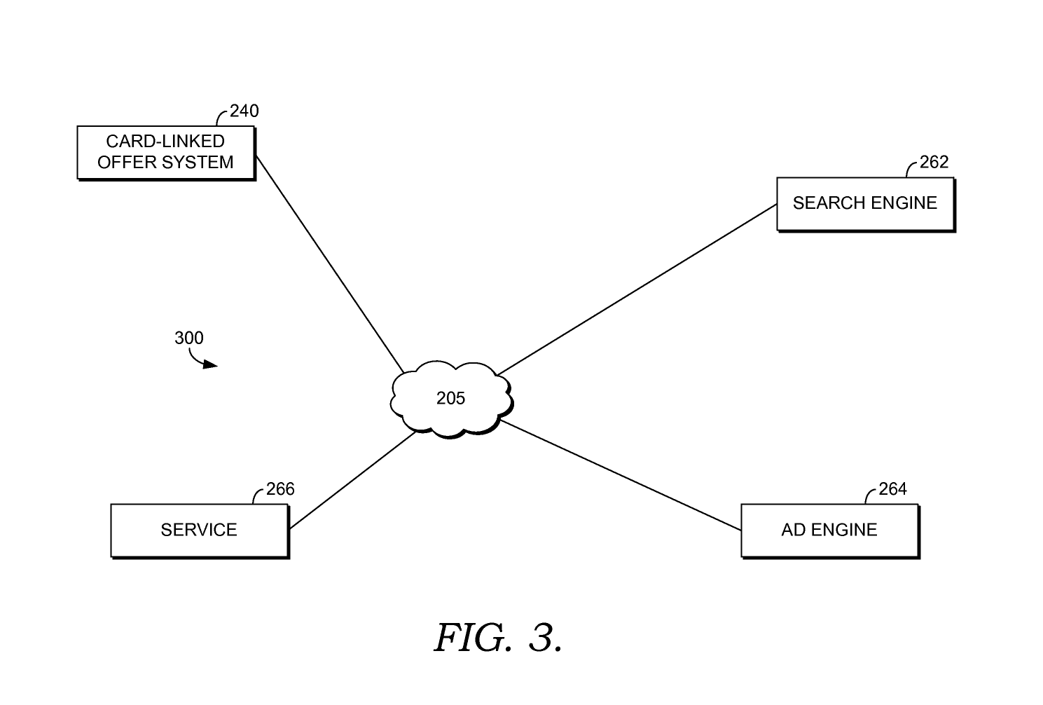

Turning now to FIG. 3, a card-linked offer environment 300 suitable for using card-linked offer data to determine user interest is provided, in accordance with an aspect of the present invention. Environment 300 includes card-linked offer system 240, search engine 262, ad engine 264, and service 266. The card-linked offer system has been described previously with reference to FIG. 2. The search engine 262, ad engine 264, and service 266 are all examples of content providers that may include an interest component similar to interest component 260. Interest component 260 uses one or more intense signals to determine a user's interest and select relevant content.

In aspects of the present invention, the card-linked offer system 240 may communicate card-linked offer data to the content providers through network 205. The card-linked offer data may be converted to a form that is consumable by an interest component associated with the content providers to eliminate the need for retraining classifiers used by content providers to determine interest. For example, the card-linked offer data could take the form of an advertising segment that can be associated with a particular user. Alternatively, the card-linked offer data could take the form of an artificial search record that may be consumed by an interest classifier without the need to retrain the classifier.

Exemplary services 266, include a personal digital assistant service that provides one or more services to a user through the user's computing devices, including smartphones and tablets. The personal digital assistant service may automatically generate calendar entries and suggest services based on an understanding of the user's interests and intents. Other exemplary services 266 include specialized search applications such as a reservation application, a travel application, an entertainment application, and such.

Turning now to FIG. 4, a method 400 for using card-linked offer data to detect user interests is provided, according to an aspect of the present invention. Method 400 may be performed by a component of a card-linked offer system. Alternatively, the method 400 may be performed by an interest component associated with a content provider. Exemplary content providers include search engines, advertising engines, and service providers.

In step 410, one or more artificial search records are generated by extracting keywords from a user's card-linked offer data and arranging the keywords into a form consistent with an actual search record. The artificial search records can take different forms including a query, a click log, and a browsing history. The artificial search records are formatted in a way that they can be consumed by an interest component without needing to retrain the interest component. For example, an interest component may use a classifier that uses query records to determine a user's interests. The classifier may be able to accept query records having a specific format. In this case, the artificial search records are generated to conform with the specific format. Different artificial search records can be generated for different interest components. In each case, the form of the artificial search records can be tailored to the needs of the interest component that will receive the artificial search records.

A user's interactions with card-linked offers can generate card-linked offer data. User interactions can include various interactions with an offer, including ignoring an offer and accepting an offer. An offer is accepted when the offer is linked to the user's credit card. Once accepted, the offer can be redeemed when the user makes a purchase consistent with the offer using the credit card.

Further data may be available when an offer invitation is ignored, such as whether or not the user read the offer invitation. User interactions can also include redeeming an accepted offer with a vendor. Additional data associated with a redemption can include a time of purchase and a location of the vendor where the purchase was made.

In another instance, an offer is accepted and not redeemed, though an unsuccessful attempt to redeem the offer is detected. The reason for the unsuccessful attempt can be another signal for an interest classifier. For example, an unsuccessful redemption attempt can occur when the user tries to redeem the offer by visiting a participating merchant but didn't meet the offer's qualifications. The user's non-conformance with the offer qualifications can provide useful information about the user. This information can be used to detect user interests and adjust future offers, and provide content that matches the user interests. For example, a user may try to redeem an offer at one of a merchants non-participating locations. This signal can nevertheless be used to determine an affinity for the store location where the attempt to redeem was made.

As step 420, the one or more artificial search records are communicated to an interest component that uses the one or more artificial search records to determine a user interest. The interest component may be associated with a search engine, an advertising engine, or some other content provider that selects content using interests.

In one aspect, the artificial search record takes the form of an artificial query record or an artificial query. The artificial query record can conform to a format for a record generated in response to an actual query. The artificial query record may be added to an existing record of a user's search queries by an interest component that receives the artificial query record. An actual search query record may describe the search query, search results returned in response to the search query, and any search results selected by the user. The search record may also include the day and time when the search query was submitted. The artificial query record can include the same information. For example, the day and time associated with an artificial search record can be the day and time an offer was accepted or redeemed.

In one aspect, the artificial search record can be an artificial query as distinguished from an artificial query record. The artificial query can mimic a keyword or natural language query submitted by a user. In one aspect, an artificial query is generated as part of an intermediate step to generate an artificial query record. Aspects of the invention may generate an artificial query and then process the artificial query using the same methods used to process an actual query to generate the artificial query record. For example, a natural language query may be processed to eliminate stopwords, punctuation, and other elements. In this case, the one or more artificial queries can take the post-processed form within the artificial search record. In one aspect, the artificial query record can take the form of an n-gram.

In one case, a separate artificial search record may be generated for each event associated with an offer within the card-linked offer data. For example, a first artificial search record may be generated when an offer is accepted and a second artificial search record may be generated when offer is redeemed. In one case, the interest signal within the artificial search record is strengthened when an offer is redeemed compared to when an offer is accepted. For example, an artificial search record associated with the acceptance of an offer may include a query with keywords describing the offer but no quick information. In contrast, an artificial search record associated with redeeming the same offer may include the same query and an artificial record of the user clicking on a webpage associated with the vendor tied to the offer. When available, the vendor webpage having the most in common with the offer may be indicated as clicked by the user within the artificial record.

As mentioned, search queries can take different forms and artificial search records can be generated to account for the different forms. For example, keyword queries and natural language queries are two common query forms. A keyword search may be a single keyword or a series of keywords. Keyword queries comprising multiple keywords may include one or more Boolean operators. A natural language query may comprise a question or statement that conforms with the grammatical structure of a human language.

The format selected for the one or more artificial queries or query records depends on the component that will use the one or more artificial queries to detect a user interest. For example, an interest component associated with an advertising system may be designed to determine a user's interests based on keyword queries. In this case, the artificial query records or artificial queries, though, can take the form of keyword queries. Artificial keyword queries can be generated by extracting keywords from an offer and combining them into one or more artificial queries. Multiple artificial queries may be generated from a single offer. Keywords within an offer can include the name of the vendor, the location of a vendor, the name of a good or service associated with the offer, and such.

Turning now to FIG. 5, a method 500 for using card-linked offer data to detect user interests is provided, according to an aspect of the present invention. Method 500 may be performed by a component of a card-linked offer system. Alternatively, the method 500 may be performed by an interest component associated with a content provider. Exemplary content providers include search engines, advertising engines, and service providers.

At step 510, an advertising segment is assigned to a user by processing the user's card-linked offer data with a machine classifier to determine an interest for the user. The user's card-linked offer data comprises offers that were accepted by the user but not redeemed by the user. The card-linked offer data can also include offers redeemed by the user in offers received by the user but not accepted. The card-linked offer data can also include offer details, including information identifying the vendor that made the offer.

An advertising segment is a category of advertising in which the user may be interested. An advertising system may select a cookie that describes an advertising segment associated with the related intent and upload it to the user's computer. Advertising entities may then use the cookie to select advertisements in which the user may be interested.

A machine classifier may be trained to interpret card-linked offer data to assign a user interest that is used to assign an advertising segment related to the interest. A supervised learning approach may be used to train the machine classifier. In one aspect, card-linked offer data is editorially tagged with related interest to create a corpus of training data for the machine classifier. The training data is then used to calculate an interest upon receiving card-linked offer data for a particular user.

Certain interests may be ascertained by evaluation of card-linked offer data apart from a classifier. For example, a heat map could be generated to determine where a user likes to shop. Shopping districts associated with multiple redeemed offers will receive a higher ranking on the heat map than shopping districts where fewer or no offers have been redeemed. Similarly, a preferred shopping time may be determined by analyzing when offers are redeemed.

In one aspect, user interests determined using card-linked offer data may be combined with user interests determined by classifiers taking other user interest signals as input. The different interest determinations may be weighed against each other to form a combined user interest profile. For example, a first classifier may determine a user interest based on search logs, a second classifier may determine a user interest based on browsing history, a third classifier may determine a user interest based on analysis of the user's social network, and a fourth classifier may determine a user interest by analyzing card-linked offer data. The user interest profile may include a ranking of interests or interest strengths. In one aspect, the card-linked offer data interest determination is given more weight than other classifiers when generating the combined user interest profile.

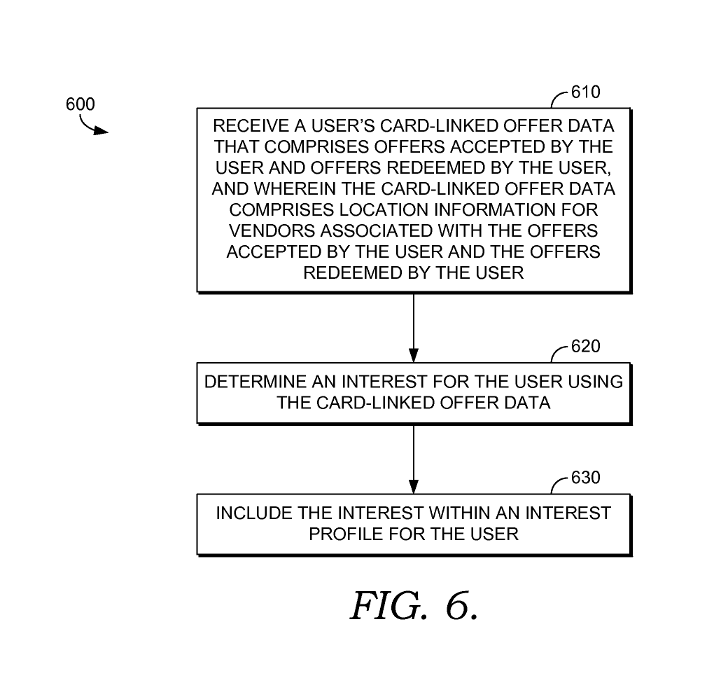

Turning now to FIG. 6, a method 600 for using card-linked offer data to detect user interests is provided, according to an aspect of the present invention. Method 600 may be performed by a component of a card-linked offer system. Alternatively, the method 600 may be performed by an interest component associated with a content provider. Exemplary content providers include search engines, advertising engines, and service providers.

At step 610, a user's card-linked offer data that comprises offers accepted by the user and offers redeemed by the user is received. The user's card-linked offer data comprises location information for vendors associated with the offers accepted by the user and the offers redeemed by the user.

At step 620, an interest for the user is determined using the card-linked offer data. In one aspect, the interest includes the user's preferred shopping district. The profile could include multiple preferred shopping districts. Preferred shopping districts include those where the user redeems above a threshold percentage of offers. A shopping district may have a variable size and shape. For example, the bounds for a shopping mall can include the mall proper and the surrounding area. The surrounding area may be editorially determined to encompass an area that a person is likely to associate with a mall area. Alternatively, the surrounding area may be derived by analyzing location data derived from multiple users over time to generate a location “hot spot” around the mall. In one aspect, the shopping district could be a broader area, such as downtown Seattle or Bellevue. This pattern might be consistent with a person that lives in Bellevue and works downtown.

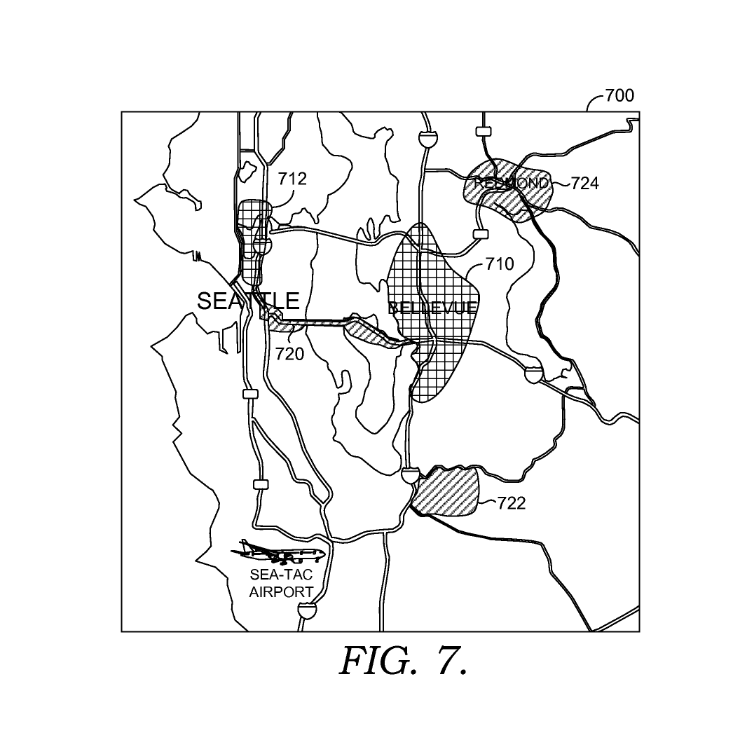

Turning now to FIG. 7, a map 700 of a user's preferred shopping zones within the Seattle metropolitan area is provided, in accordance with an aspect of the present invention. A person can have different levels of preference with different shopping zones. Aspects of the present invention analyze offer data to determine a user's shopping frequency with different areas or zones. Three different preference levels are shown on map 700. Shopping zone 710 and shopping zone 712 are assigned the highest level of preference. Shopping zone 720, zone 722, and shopping zone 724 are assigned a medium level of preference. All other areas of the Seattle metropolitan area are assigned a low level of preference. Aspects of the present invention are not limited to using three preference levels.

Shopping zone 710 corresponds to the city of Bellevue. In the present example, the user may live in the city of Bellevue and commute through preference zone 720 to Seattle. The user may work in preference zone 712, which does not encompass the entire city of Seattle but only an area where the user's card-linked offer data indicates the user shops a significant amount. Because the user either lives or works in preference zones 710 and 712, the user may be assumed to prefer shopping in these areas or be interested in other events within these areas. As explained previously, search results, advertisements, and other content may be customized based on preferred shopping zones.

Shopping zone 720 covers the user's commute route between Seattle and Bellevue. Shopping zone 720 is assigned a medium level of preference. While the user is frequently present within shopping zone 720, the user may not shop within familiarity zone 720 on a frequent basis. For example, the user may stop to get coffee or food only within zone 720. This illustrates that the shopping zone can be assigned based the type of activities that the user is engaged in while in the zone.

Shopping zone 724 and shopping zone 722 are assigned a medium level of preference. Notice that the route to these zones is classified as low (low preference is designated by the absence of hashing), indicating that the user does not accept offers or redeem offers by vendors on a route to these locations above a threshold required to satisfy a medium level preference. In this example, the user previously lived near shopping zone 722 and previously worked in shopping zone 724. The user may still visit these zones on occasion.

Though not shown, zones 722 and 724 were previously assigned a high preference level when the user redeemed offers with vendors the zones. The current medium preference level illustrates that the preference level can be adjusted based on recent card-linked activity. In effect, the preference assignment algorithm can give more weight to recent offer data causing the preference zone rating to decay over time when the user redeems or accepts less offers associated with vendors in an area. The preference level zone decay is appropriate because shopping patterns change over time, and it may not be desirable to assume that the user has an interest in shopping within an area absent recent activity in the area.

In one aspect, the shopping zones are derived from a heat map. A heat map organizes a user's location data into regions running, metaphorically, from hot to cold. The hot areas can represent areas the shops in frequently and the cold areas represent areas the user never visits. A great number of gradients between hot and cold are possible. The heat map can delineate small differences in a user's shopping preference. For example, an area the user shops in five times a week may be differentiated from an area the user shops in six times a week. The shopping zones may be mapped to a threshold range in the heat map. For example, areas having a shopping frequency above a threshold may be assigned a certain preference range. Thus, an area a user shops in five times a week may be grouped into the same shopping zone as an area shops in six times a week.

The threshold used to form a shopping zone may be established editorially. In other words, the threshold can be set editorially to identify areas the user has different levels of shopping activity in a way that maps to likely interest. Alternatively, in one aspect a preference zone is a range within the heat map and the actual familiarity zones need not be delineated as shown in FIG. 7. Instead, the interest is defined by a range on the heat map.

Different shopping zones can be associated with different categories of products. For example, a user may eat lunch in one zone, eat dinner in another zone, shop for clothes in another, and buy coffee in yet another zone. The different shopping zones can be used to anticipate the types of products a user is interested in purchasing while in a particular zone.

Returning to FIG. 6, at step 630, the interest is included within an interest profile for the user. The interest profile can include multiple interests. The interests can take the form of favored shopping districts or shopping times. The interests can also designate categories of goods or services that are of interest to the user.

Aspects of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer storage media having computer-executable instructions embodied thereon that, when executed by a computing device, perform a method for using card-linked offer data to detect user interests, the method comprising:
generating one or more artificial search records by extracting keywords from a user's card-linked offer data and arranging the keywords into a format consistent with an entry within actual search records; and
communicating the one or more artificial search records to an interest component that uses the one or more artificial search records to determine a user interest.

2. The media of claim 1, wherein the card-linked offer data comprises card-linked offers the user subscribed to.

3. The media of claim 1, wherein the card-linked offer data comprises card-linked offers the user redeemed.

4. The media of claim 1, wherein the card-linked offer data comprises card-linked offers the user unsuccessfully attempted to redeem.

5. The media of claim 1, wherein the interest component is a search engine that uses the one or more artificial search records to determine an interest for the user

6. The media of claim 1, wherein the one or more artificial search records comprise one or more artificial queries.

7. The media of claim 6, wherein the one or more artificial queries each comprise an n-gram having a format compatible with a natural language search query after the search engine processes the natural language search query.

8. A method for using card-linked offer data to detect user interests, the method comprising:
assigning, at a computing device, an advertising segment to a user by processing the user's card-linked offer data with a machine classifier to determine an interest for the user, wherein the user's card-linked offer data comprises offers that were accepted by the user but not redeemed by the user.

9. The method of claim 8, wherein the machine classifier is trained with a supervised learning process that uses tagged card-linked offer data as a training input.

10. The method of claim 8, wherein the advertising segment identifies an interest that the user does not have as derived from offers the user received and did not accept.

11. The method of claim 8, wherein the interest is a preferred shopping district associated with one or more vendors where the user redeemed a card-linked offer.

12. The method of claim 8, wherein the interest is a time period designating a peak shopping period derived from offer redemption times included within the user's card-linked offer data.

13. The method of claim 8, wherein the interest is a preferred purchase motivation derived from offer content and purchases recorded within the user's card-linked offer data.

14. The method of claim 13, wherein the preferred purchase motivation comprises one of discount, novelty, personal health, environmental friendliness, and convenience.

15. A method for using card-linked offer data to detect user interests, the method comprising:
receiving a user's card-linked offer data that comprises offers accepted by the user and offers redeemed by the user, and wherein the user's card-linked offer data comprises location information for vendors associated with the offers accepted by the user and the offers redeemed by the user;
determining an interest for the user using the card-linked offer data; and
including the interest within an interest profile for the user.

16. The method of claim 15, further comprising associating an advertising segment with the user that is related to the interest.

17. The method of claim 16, further comprising using the advertising segment to select an advertisement to display to the user.

18. The method of claim 15, wherein the interest is a preferred shopping time period derived from offer redemption times included within the user's card-linked offer data.

19. The method of claim 15, wherein the interest is a preferred shopping district derived from the location information for vendors associated with the offers accepted by the user and the offers redeemed by the user.

20. The method of claim 19, wherein the preferred shopping district is further derived from a location of vendors associated with offers that are not accepted by the user.
